(19) United States
(12) Patent Application Publication
(10) Pub. No.: US 2016/0012932 A1
(43) Pub. Date: Jan. 14, 2016

(54) Composite Formulation and Electronic Component

(71) Applicant: Tyco Electronics Corporation, Berwyn, PA (US)

(72) Inventors: Aaron Holm, Redwood City, CA (US); Dominique Freckmann, San Francisco, CA (US); Jennifer L. Robison, San Mateo, CA (US); Mark F. Wartenberg, Redwood City, CA (US); Jialing Wang, Mountain View, CA (US); Josh H. Golden, Aptos, CA (US); Ting Gao, Palo Alto, CA (US)

(73) Assignee: Tyco Electronics Corporation, Berwyn, PA (US)

(21) Appl. No.: 14/329,616

(22) Filed: Jul. 11, 2014

(51) Int. Cl. H01B 1/22

(52) U.S. Cl. CPC H01B 1/22

(57) ABSTRACT

A composite formulation and electrical component are disclosed. The composite formulation includes a polymer matrix having at least 15% crystallinity and process-aid-treated copper-containing particles blended with the polymer matrix including higher aspect ratio particles and lower aspect ratio particles. The higher ratio particles and the lower ratio particles produce a decreased percolation threshold for the composite formulation when processed by extrusion or molding, the decreased percolation threshold being compared to a similar composition that fails to include the first particle and the second particles. The electrical component includes a composite product produced from the composite formulation and is selected from the group consisting of an antenna, electromagnetic interference shielding device, a connector housing, and combinations thereof.

### FIELD OF THE INVENTION

The present invention is directed to formulations and manufactured products. More particularly, the present invention is directed to composite formulations and electronic components having composite products formed from composite formulations having process-aid-treated metal particles.

### BACKGROUND OF THE INVENTION

Electrically conductive materials are useful in a variety of components. Lowering the resistivity and, thus, increasing the conductivity is desirable for improving such components. Extending the useful life of such components is also desirable. Further improvements to such components permit wider use in more environments.

Copper particles can be used in materials to produce relatively good electrically conductive composite formulations. However, such materials are not capable of use in certain applications due to copper's susceptibility to oxidation and consequently the loss of conductivity of the composite materials, and are not as conductive as materials including silver. However, silver is expensive and may not be practical for certain applications for economic reasons.

Decreasing resistivity and, thus, increasing conductivity of materials, without sacrificing cost, operational complexity, or functional properties continues to be desirable in the art.

A composite formulation and composite product that shows one or more improvements in comparison to the prior art would be desirable in the art.

### BRIEF DESCRIPTION OF THE INVENTION

In an embodiment, a composite formulation includes a polymer matrix having at least 15% crystallinity and process-aid-treated metal particles blended with the polymer matrix including first particles and second particles with the first particles having a first aspect ratio and the second particles having a second aspect ratio, and the first aspect ratio being greater than the second aspect ratio. The first particles and the second particles produce a decreased percolation threshold for the composite formulation when processed by extrusion or molding, the decreased percolation threshold being compared to a similar composition that fails to include the first particle and the second particles.

In another embodiment, an electronic component includes a composite product produced from a composite formulation, the composite formulation having a polymer matrix having at least 15% crystallinity and process-aid-treated metal particles blended with the polymer matrix including first particles and second particles with the first particles having a first aspect ratio and the second particles having a second aspect ratio and the first aspect ratio being greater than the second aspect ratio, the first particles and the second particles producing a decreased percolation threshold for the composite formulation when processed by extrusion or molding, the decreased percolation threshold being compared to a similar composition that fails to include the first particle and the second particles. The electronic component is selected from the group consisting of an antenna, an electromagnetic interference (EMI) shield, a connector housing, and combinations thereof.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a schematic view of a composite formulation having a polymer matrix and process-aid-treated metal particles, according to an embodiment of the disclosure.

FIG. 2 is a perspective view of an EMI shield that is a composite product formed from a composite formulation, according to an embodiment of the disclosure.

FIG. 3 is a perspective view of an electrical connector that is a composite product formed from a composite formulation, according to an embodiment of the disclosure.

FIG. 4 is a perspective view of an antenna that is a composite product formed from a composite formulation, according to an embodiment of the disclosure.

FIG. 5 shows a scanning electron micrograph of first particles and second particles that are constituents of process-aid-treated metal particles blended within a polymer matrix of a composite formulation, according to an embodiment of the disclosure.

FIG. 6 shows a schematic sectioned view of first particles and second particles that are constituents of process-aid-treated metal particles blended within a polymer matrix of a composite formulation, according to an embodiment of the disclosure.

Wherever possible, the same reference numbers will be used throughout the drawings to represent the same parts.

### DETAILED DESCRIPTION OF THE INVENTION

Provided are a composite formulation and a composite product produced from a composite formulation. Embodiments of the present disclosure, for example, in comparison to similar concepts failing to disclose one or more of the features disclosed here, have homogeneously dispersed particles forming a conductive network within the polymer matrix, have high conductivity by selecting morphologies and aspect ratios of process-aid-treated metal particles and the loading levels of such particles without compromising the processability, have increased oxidation inhibition and extended operational life (for example, based upon aging data), are capable of being soldered, are capable of being extruded, are capable of being molded, and/or are capable of other advantages and distinctions apparent from the present disclosure.

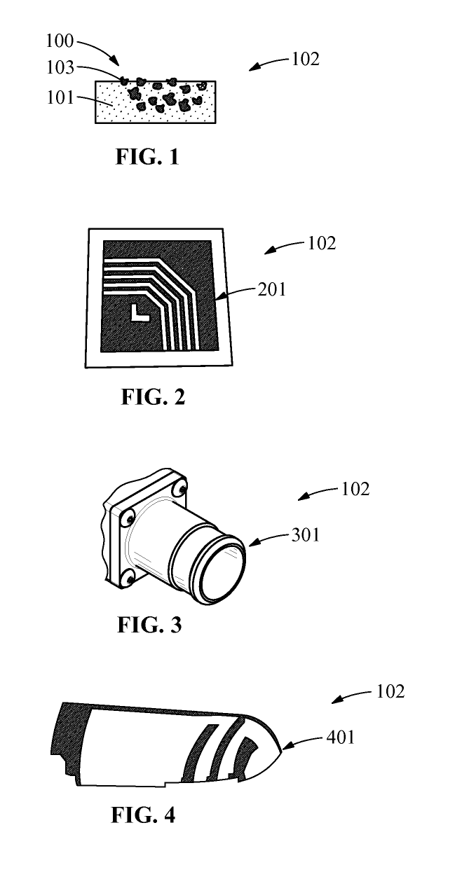

Referring to FIG. 1, a composite formulation 100 includes a polymer matrix 101 and process-aid-treated metal particles 103, for example, homogenously blended and/or with the polymer matrix 101, having the concentration, by volume, of between 40% and 75% for the polymer matrix, and between 25% and 50% for the process-aid-treated metal particles, respectively. The blending is by any suitable technique, such as twin-screw extrusion or bowl mixing.

The polymer matrix 101 includes any suitable material capable of having the process-aid-treated metal particles 103 blended within it. Suitable materials include, but are not limited to, fluoropolymers (for example, polyvinylidene fluoride (PVDF), PVDF/hexafluoropropylene (HFP) copolymer, PVDF/HFP tetrafluoroethylene (TFE) terpolymer, fluorinated ethylene propylene (FEP), ethylene tetrafluoroethylene (ETFE)), polyethylene (PE), polypropylene (PP), polyethylene terephthalate, polybutylene terephthalate (PBT), liquid crystalline polymer (LCP), polycarbonate (PC), polyamide (PA), and polyphenylene sulfide (PPS). The polymer matrix 101 permits the composite formulation 100 to be extruded, molded (for example, injection molded, compression-molded, vacuum formed, or a combination thereof), or a combination thereof.

The polymer matrix 101 has a crystallinity within a suitable range for providing the physical properties desirable for good processability and for assisting the formation of the conductive filler network to achieve desired high electrical conductivity. Depending on the specific polymer material, the crystallinity of the polymer is at least 15%. As used herein, the term “crystallinity” refers to ordered orientation and/or structure of molecules versus a random orientation and/or structure. The ordered structures of molecules also include the crystal mesophases where the molecules exist in three-dimensional crystal lattice but do not have the rotational order, as in the case of LCP. For polymers other than LCP, the optimum crystallinity of the polymer should be the balance or less than the balance of the total concentration of the conductive fillers and other additives in the composite formulations.

The composite formulation 100 includes any other suitable constituents for processability. In one embodiment, a process aid is blended within the polymer matrix 101, for example, at a concentration, by volume, of between 5% and 12%. It is preferred that there be at least 5% of the process aid, preferably at least 6%, particularly at least 7% by volume of composite formulation. The selection of the plasticizer ensures the compatibility of the plasticizer with the polymer matrix and any surface treatment of the metal particles as received from commercial vendors. In one embodiment, the process aid is dioctyl sebacate (DOS). In another embodiment, the process aid is a polyester plasticizer. The process aid is tumble blended onto the metal particles prior to the addition to the polymer matrix. The resulting advantages of such treatment include homogeneous dispersion of the metal particles in the polymer matrix, the significant reduction of the melt viscosity of the composite formulation, and the improvement of the electrical conductivity of the composite formulation. In one embodiment, the viscosity of the composite formulation comprising the DOS-treated metal particles and PVDF matrix is lower than that of the neat PVDF matrix.

Other suitable constituents capable of being blended within the polymer matrix 101 include, but are not limited to, a lubricant (for example, steric acid, or oleic acid), a crosslinking agent, an antioxidant, a metal deactivator, a coupling agent, a curing agent (for example, for chemical curing and/or for radiation curing), a wetting agent, a flame retardant, a pigment or dye, or the combination thereof.

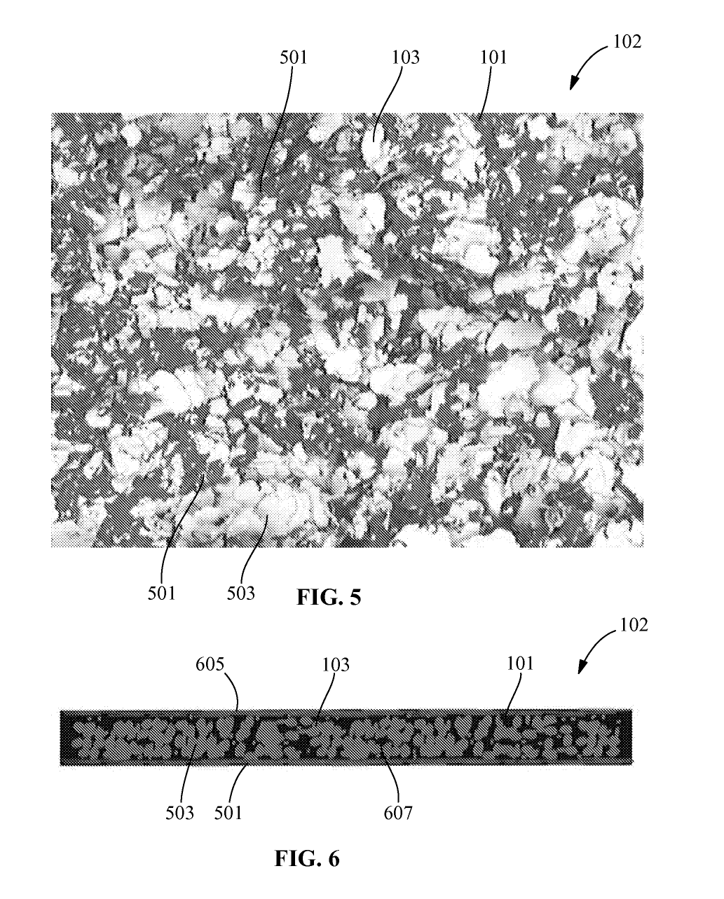

Referring to FIGS. 5-6, the process-aid-treated metal particles 103 in the composite formulation 100 include first particles 501 and second particles 503. In one embodiment, the first particles 501 form a concentration of the process-aid-treated metal particles 103, by volume, that is higher than a concentration of the second particles 503. Suitable concentrations for the first particles 501 in the composite formulation range from 15%-30%. Suitable concentrations for the second particles 503 in the composite formulation range from 10%-20%. In one embodiment, the aspect ratios of the first particles 501 in comparison to the aspect ratios of the second particles 503 are at least twice greater. In one embodiment, the aspect ratios of the first particles 501 and the second particles 503 are selected to reduce the percolation threshold to produce a decreased percolation threshold. As used herein, the phrase “decreased percolation threshold” refers to being compared to a similar composition that fails to include the first particle 501 and the second particles 503. In one embodiment, the percolation threshold is between 20% and 30%, for example, with a concentration being between 20% and 30% by volume, of the process-aid-treated metal particles 103 in the composite formulation.

Referring to FIGS. 5-6, the definitions of the aspect ratios of metal particles according to the present invention are: the largest dimension to the smallest dimension of the flattened surface for the flakes, length to primary dendrite width for the dendrites, length to diameter for the fibers, the largest dimension to the smallest dimension, as determined based on the largest and shortest distance between two concave surfaces delimiting the spheroids, for the spheroids.

The process-aid-treated metal particles 103 include two or more types of metals, one of which is copper or a copper alloy. In one embodiment, process-aid-treated metal particles 103 further include tin, aluminum, stainless steel, silver, nickel, metallic alloys including such materials, or a combination thereof.

The first particles 501 and the second particles 503 differ in size. Suitable maximum dimensions for the first particles 501 are less than 400 μm. Suitable maximum dimensions for the second particles 503 are less than 100 μm.

The first particles 501 and the second particles 503 differ in morphologies. Suitable morphologies for the process-aid-treated metal particles 103 include, but are not limited to, dendrites, spheroid particles, flakes, fibers, or a combination thereof. In one embodiment, the first particles 501 include dendrites, flakes, fibers, or a combination thereof. In one embodiment, the second particles 503 include a morphology of spheroids, flakes, dendrites, or a combination thereof. In one embodiment, the process-aid-treated metal particles 103 include two morphologies (thereby being binary), three morphologies (thereby being ternary), or four morphologies (thereby being quaternary).

In one embodiment, the selection of the metal particles 103 permit(s) unique properties to be produced. For example, as shown in FIG. 6, in one embodiment, the metal particle 503 are supplied, or can be treated, with a lubricant coating on the surface, have a tap density lower than that of the metal particle 501, and can be positioned proximal to a surface 605 of the composite product 102. The lubricant creates a barrier, that increases oxidation resistance and as a result the composite formulation can retain high conductivity over a period of 21 days or longer as tested in dry air at 85° C. In contrast, the composite formulation without such lubricant-treated metal particle 503 loses conductivity within a few hours.

The composite formulation 100 provides a bulk resistivity of less than 0.0004 ohm·cm at 23° C. and contact resistance of less than 500 milliohm measured at 200 grams force per ASTM B539-02, at 30% by volume of process-aid-treated metal particles in a composite formulation, with processability suitable for extrusion or molding. Based upon such a conductivity and processability, the composite formulation 100 is capable of being used in a composite product 102, for example, an EMI shield 201 (see FIG. 2), an electrical connector 301 (see FIG. 3) such as an integrated connector, an antenna 401 (see FIG. 4), or another suitable electronic device.

### EXAMPLES

In a first example, the polymer matrix is a copolymer of PVDF and HFP with a crystallinity of 30%-35%, the metal particles include copper dendrites and copper flakes treated with DOS prior to the addition to the polymer matrix. The aspect ratio of the copper dendrites is between 5:1 and 10:1, and the aspect ratio of the Cu flakes is between 2:1 and 5:1. The size of the copper dendrites is 12-50 μm and the size of the copper flakes is 40-140 μm. The concentration of the copper dendrites in the composite formulation is 15%-20% by volume and that of the copper flakes is 10%-15% by volume. The concentration of DOS in the composite formulation is 5-12% by volume. The resistivity of such composite formulation is 0.003 ohm.cm or less at 23° C. The contact resistance of such composite formulation is 500 m Ω or less, measured at 200 gram force per ASTM B539-02.

In a second example, the polymer matrix is a copolymer of PVDF and HFP with a crystallinity of 30%-35%, the metal particles include copper dendrites and copper flakes treated with DOS prior to the addition to the polymer matrix. The aspect ratio of the copper dendrites is between 5:1 and 10:1 and that of the Cu flakes is between 2:1 and 5:1. The size of the copper dendrites is 12-50 μm and the size of the copper flakes is 40-140 μm. The concentration of the copper dendrites in the composite formulation is 22%-26% by volume and that of the copper flakes is 15%-20%. The concentration of DOS in the composite formulation is 5-12%. The resistivity of such composite formulation is 0.001 ohm.cm or less at 23° C. The contact resistance of such composite formulation is 150 m Ω or less, measured at 200 gram force per ASTM B539-02.

In a third example, the polymer matrix is an LCP, the metal particles include copper dendrites and copper flakes treated with DOS prior to the addition to the polymer matrix. The aspect ratio of the copper dendrites is between 5:1 and 10:1 and that of the Cu flakes is between 2:1 and 5:1. The size of the copper dendrites is 12-50 μm and the size of the copper flakes is 40-140 μm. The concentration of the copper dendrites in the composite formulation is 22%-26% by volume and that of the copper flakes is 14%-18%. The concentration of DOS in the composite formulation is 5-12%. The resistivity of such composite formulation is 0.0005 ohm.cm or less at 23° C. The contact resistance of such composite formulation is 500 milliohm or less, measured at 200 gram force per ASTM B539-02.

In a fourth example, the polymer matrix is an LCP, the metal particles include copper dendrites and copper flakes treated with DOS prior to the addition to the polymer matrix. The aspect ratio of the copper dendrites is between 5:1 and 10:1 and that of the Cu flakes is between 2:1 and 5:1. The size of the copper dendrites is 12-50 μm and the size of the copper flakes is 40-140 μm. The concentration of the copper dendrites in the composite formulation is 25%-30% by volume and that of the copper flakes is 16%-20%. The concentration of DOS in the composite formulation is 5-12%. The resistivity of such composite formulation is 0.0002 ohm.cm or less at 23° C. The contact resistance of such composite formulation is 200 milliohm or less, measured at 200 gram force per ASTM B539-02.

While the invention has been described with reference to one or more embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A composite formulation, comprising:
a polymer matrix having at least 15% crystallinity; and
metal particles blended with the polymer matrix including first particles having a first aspect ratio and second particles having a second aspect ratio, the first aspect ratio being greater than the second aspect ratio; and
at least 5% process aid, by volume, of composite formulation coated on the first and second particles;
wherein the first particles and the second particles produce a decreased percolation threshold for the composite formulation when processed by extrusion or molding, the decreased percolation threshold being compared to a similar composition that fails to include the first particle and the second particles.

2. The composite formulation of claim 1, wherein the process-aid comprises dioctyl sebacate.

3. The composite formulation of claim 1, wherein the process-aid comprises a plasticizer comprising polyester.

4. The composite formulation of claim 1, wherein the first particles are at a concentration in the composite formulation, by volume, of between 15% and 30% and the second particles are at a concentration in the composite formulation, by volume, of between 10% and 20%.

5. The composite formulation of claim 1, wherein the first particles have an aspect ratio that is at least twice greater than the second particles.

6. The composite formulation of claim 1, wherein the first particles are dendrites, flakes, or fibers.

7. The composite formulation of claim 1, wherein the second particles are dendrites, flakes, or spheroid particles.

8. The composite formulation of claim 1, wherein the first particles have a maximum dimension of less than 400 micrometers.

9. The composite formulation of claim 1, wherein the second particles have a maximum dimension of less than 100 micrometers.

10. The composite formulation of claim 1, wherein the metal particles are copper-containing particles and are selected from the group consisting of dendrites, spheroid particles, flakes, and fibers.

11. The composite formulation of claim 10, wherein the copper-containing particles include one or more of tin, aluminum, stainless steel, silver, and nickel.

12. The composite formulation of claim 1, wherein the metal particles include one or more of tin, aluminum, stainless steel, silver, and nickel.

13. The composite formulation of claim 1, wherein the composite formulation is extrudable.

14. The composite formulation of claim 1, wherein the composite formulation is moldable.

15. The composite formulation of claim 1, wherein the polymer matrix includes polyvinylidene fluoride, polyvinylidene fluoride/hexafluoropropylene copolymer polyvinylidene fluoride/tetrafluoroethylene/hexafluoropropylene terpolymer, ethylene tetrafluoroethylene, fluorinated ethylene propylene, polyethylene, polypropylene, polyethylene terephthalate, polybutylene terephthalate, liquid crystalline polymer, polycarbonate, polyamide, polyphenylene sulfide, or a combination thereof.

16. The composite formulation of claim 1, wherein the composite formulation has a resistivity of less than 0.004 ohm.cm at 23° C.

17. The composite formulation of claim 1, wherein the composite formulation has a contact resistance of less than 0.5 ohms at forces of 200 gram force per ASTM B539-02.

18. An electrical component produced from a composite formulation, the composite formulation comprising:
a polymer matrix having at least 15% crystallinity;
metal particles blended with the polymer matrix including first particles having a first aspect ratio and second particles having a second aspect ratio, the first aspect ratio being greater than the second aspect ratio; and
at least 5% process aid, by volume, of the composite formulation coated on the first and second particles;
wherein the first particles and the second particles produce a decreased percolation threshold for the composite formulation when processed by extrusion or molding, the decreased percolation threshold being compared to a similar composition that fails to include the first particle and the second particles; and
wherein the electrical component is selected from the group consisting of an antenna, electromagnetic interference shielding device, a connector housing, and combinations thereof.

19. The electrical component of claim 18, wherein the composite product is formed by extrusion or molding.
